(19) United States
(12) Patent Application Publication
(10) Pub. No.: US 2019/0291351 A1
(43) Pub. Date: Sep. 26, 2019

(54) Pouch Machine with Quick Change Die and Adjustable Die Position

(71) Applicant: CMD Corporation, Appleton, WI (US)

(72) Inventors: Kevin M. Lysne, Fremont, WI (US); Douglas J. Main, Hortonville, WI (US); Clint J. Henne, Abrams, WI (US); Mark C. Krueger, Green Bay, WI (US)

(73) Assignee: CMD Corporation, Appleton, WI (US)

(21) Appl. No.: 16/361,987

(22) Filed: Mar. 22, 2019

Related U.S. Application Data
(60) Provisional application No. 62/647,278, filed on Mar. 23, 2018.

(51) Int. Cl. B29C 65/20; B29C 65/00

(52) U.S. Cl. CPC B29C 65/20; B29C 66/8322; B31B 2155/00; B29C 66/8511; B29C 66/43

(57) ABSTRACT

A method and apparatus for making pouches is disclosed. The pouches are made with at least one seal bar. The seal bar includes a base that is not removable and a removable sealing member that is held to the base using at least one easy release structure. A seal bar with a top member and a mating bottom member can also be included. The top member is above a film and the bottom member is below the film. A seal is formed on the film where the top member and bottom member mate. A linkage connects the top member and the bottom member such that when an adjustment of the position of one of the top member and the bottom member in a plane parallel to the film is made, a like adjustment a second plane parallel to the film is made to the other of the top member and the bottom member.

### FIELD OF THE INVENTION

The present disclosure relates generally to the art of pouch and bag machines. More specifically, it relates to pouch and bag machines that use one or more sealing dies or seal bars to create seals.

### BACKGROUND OF THE INVENTION

There are many known stand up pouch machines, and this invention will be explained in the context of pouch machines such as the CMD® Stand-Up Pouch Machine® or that shown in U.S. Pat. Nos. 6,976,946, 7,191,575 and 7,325,379, each of which are hereby incorporated by reference, and US Patent Publications US-20170232659, US-2014-0332138-A1 and US-2011-0207589-A1, each of which are also hereby incorporated by reference. One example of a prior art pouch machine with a zipper crush section includes an unwind or infeed section, followed by a forming or folding section, followed by a machine direction bottom seal and zipper flange sealing section, followed by a zipper crush section, followed by a side sealing section, followed by other processes such as cut off, hole punch, etc. The film is advanced and stopped, and each section operates on the portion of the film in that section. Then, when the operations are complete, the film is advanced, and each section again operates. When the film has completed the path through the machine each operations has been performed on the film, thus creating the pouch.

Pouch design have become complex, such as having any of a number of features, including closable zippers, easy open tear strings, product protecting venting, etc. These features are added with insert material or materials that are different than and/or have a different thickness than the pouch body or substrate material. Insert, as used herein, refers to a feature such as a closure (zipper, hook and loop, press to close, etc), a tear strip, a vent, plugs, valves, spouts, strips, etc. that are comprised of materials different than and/or have a different thickness than the materials comprising the pouch body or substrate.

Prior art pouch machine sealers typically included a sealing die that has the sealing surface thereon. Such prior art typically used seal dies or seal bars that are moved toward a film (or films) and use pressure and temperature to melt the film and form a seal. The sealing die is often attached to a die backing member. The sealing die can be affixed to the die backing member, such as with cap screws. However, it is sometimes desirable to change the sealing die, due to wear or to provide a different sealing profile. In such cases the entire sealer could be changed, but that can be costly and time consuming. Unscrewing the sealing die from the die backing member requires a tool and is time consuming. Some prior art machines have quick change sealing dies, that include a spring loaded L clip. Such clips are expensive. Once unclipped it can still be difficult to remove the sealing die.

Seal bars can extend in the machine directions or across the machine direction. Removing a seal bar that extends in the cross machine direction can be difficult because the bar is hot, lengthy (several feet or more, e.g.), and it is difficult to access the clips or screws holding the die in place. Some prior art designs require accessing the seal bar from upstream or downstream, which might require moving portions of the machines. Side access presents challenges because there is not an easy way to grab the hot bar, and the end opposite the end being grabbed is cantilevered and difficult to handle.

Thus, a seal bar that can be readily accessed and removed from the side is desired.

Seal dies are typically used with a mating bottom. The film is sealed between the mating members, for example with the die member above the film and the backing member below the film. The mating die and backing must be aligned for the seal to be properly formed. The location where the seals are to be formed is dictated by the layout of the pouches being made, and the location of the seals dictates the location of the sealing die and backing member.

When the pouches (or layouts) is changed, the location of the seals is also changed. Machine direction seal bars might be moved closer to or farther from the edge of the film, depending on the width of the pouches being made. Both the seal die and backing member must be moved to the same location to properly form the seal. Typical prior art systems provide one crank to move the top member, and another crank to move the bottom member. The machine operator moves turns each crank until both members are in the proper position.

However, the film is often between the top and bottom members, which makes alignment difficult. Also, the cranks used to adjust the position of the top and bottom members are often located where machine supports can obstruct the view of the sealing dies and backing members, making alignment even more difficult. Thus, prior art when changing the pouch layout prior art machines are often run, then the seal locations and quality is checked, then adjustments made to the seal and or backing location. The process is repeated until the sealing die and backing are properly aligned. This can be time consuming and waster film.

Accordingly, a pouch machine where adjusting top and bottom sealing members is not difficult is desirable.

### SUMMARY OF THE PRESENT INVENTION

According to a first aspect of the disclosure a pouch machine has at least one seal bar. The seal bar includes a base that is not removable and a removable sealing member that is held to the base using at least one easy release structure.

According to a second of the disclosure a pouch machine has at least one seal bar. The seal bar includes a top member and a mating bottom member. The top member is above a film and the bottom member is below the film. A seal is formed on the film where the top member and bottom member mate. A linkage connects the top member and the bottom member such that when an adjustment of the position of one of the top member and the bottom member in a plane parallel to the film is made, a like adjustment a second plane parallel to the film is made to the other of the top member and the bottom member.

The easy release structure is at least one of a spring, a clip and a dove tail in one alternative.

The removable sealing member is held to the base using a plurality of easy release structures in another alternative.

The plurality of easy release structures includes at least one of a spring, a clip and a dove tail in one embodiment.

The plurality of easy release structures include at least one spring, at least one clip and a at least one dove tail in various embodiments.

The removable sealing member fixedly receives a tool that can lift and remove the removable sealing member in one alternative.

The removable sealing member includes a threaded hole that threadedly receives a rod that can lift and remove the removable sealing member in another alternative.

The at least one seal bar is a cross direction or a machine direction seal bar in various embodiments.

The pouch machine also has a crank connected to the linkage, and turning the crank results in the adjustment of the position of the top member and the bottom member in one alternative.

The linkage includes at least one of a timing belt and a threaded rod in another alternative.

The pouch machine of claim 10, wherein the linkage includes both of the timing belt and the threaded rod in one embodiment.

Other principal features and advantages of will become apparent to those skilled in the art upon review of the following drawings, the detailed description and the appended claims.

### BRIEF DESCRIPTION OF THE DRAWINGS

FIG. 1 is a perspective view of seal bar;

FIG. 2 is an end view of the seal bar of FIG. 1;

FIG. 3 is a top view of the seal bar of FIG. 1;

FIG. 4 is a side view of the seal bar of FIG. 1;

FIG. 5 is an end view of the seal bar of FIG. 1;

FIG. 6 is a perspective view of the seal bar of FIG. 1;

FIG. 7 is a top view of the base of the seal bar of FIG. 1;

FIG. 8 is a side view of the base of the seal bar of FIG. 1;

FIG. 9 is a perspective view of the base of the seal bar of FIG. 1;

FIG. 10 is a perspective view of the base of the seal bar of FIG. 1;

FIG. 11 is a side view of the sealing member of the seal bar of FIG. 1;

FIG. 12 is a bottom view of the sealing member of the seal bar of FIG. 1;

FIG. 13 is a perspective view of the sealing member of the seal bar of FIG. 1;

FIG. 14 is a side view of a telon;

FIG. 15 is a pouch machine;

FIG. 16 is a tool used to remove a sealing member; i)

FIG. 17 shows linkages that connect top and bottom sealing members; and

FIG. 18 is a mount for upper and lower sealing members.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present disclosure will be illustrated with reference to a particular pouch machine and seal bar design, it should be understood at the outset that the easy to remove seal bar and adjustment of the seal bar location can also be implemented with other design and in other machines.

Generally, a quick change seal die for a pouch machine is disclosed, along with a tool used to make the change, and a mechanism and method to adjustment the top and bottom members used to form a seal to make pouches.

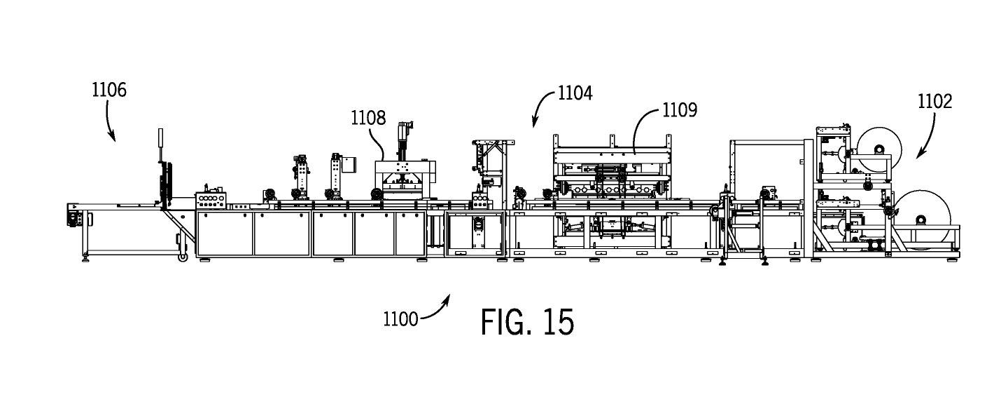

Referring now to FIG. 15, a pouch machine 1100 that uses the present invention is shown. It includes an infeed section 1102, a sealing section 1104 and an outfeed section 1106. Infeed section, as used herein, is a portion of the machine that receives material to be made into pouches, or partially made pouches, and transports them to a sealing section. Sealing section, as used herein, is the section of a pouch machine where one or more seals are imparted to form or partially form a pouch. Outfeed section, as used herein, is a portion of the machine that receives from a sealing section material that has been at least partially made into pouches, and transports them from the sealing section. Machine 1100 is an intermittent motion machine, where the film advances, then stops and the operations are performed on the film, and then the process repeats. Multiple operations cooperate to form the desired pouch.

Infeed section 1102 receives a laminate (or partially formed pouches, tube material, or a mono layer material in other embodiments), and provides the laminate, unsealed pouches, or partially formed pouches, to sealing section 1104. Sealing section 1104 includes a platen sealer 108 and bar sealers 109 and operates to impart one or more seals, in the preferred embodiment, to the laminate, thereby forming, or partially forming, the sealed pouches. The invention will be described with respect to bar sealers, but could be used with a platen. Bar sealer, as used herein, refers to a seal bar having a dimension in the machine direction much greater than in the cross direction, or a dimension in the cross direction much greater than in the machine direction.

After the pouches are made they are received by outfeed section 106 for stacking, etc. Sealed pouch, as used herein, includes pouches that have all or some of the seals that form the pouch completed. Sealer, as used herein, is a portion of a sealing section that has one or more sealing surfaces on a sealing die held against or affixed to a die backing member, as well as linkages etc that cause the sealing surfaces to move toward and away from a sealing position, and a source of heat. Unsealed pouch, as used herein, includes a pouch, or material to be made into a pouch, that has at least one seal not yet formed, and can include pouches with one or more seals formed, or no seals formed.

Pouch machine 1100 operates consistently with the prior art, and in particular consistent with the PDI® 600SS pouch machine (shaped seal), and made by CMD™ Corp., except as set forth herein. Alternatives include a continuous motion machine and/or a shuttle machine.

Generally, sealing section 104 includes one or more sealing fixtures (bars or platens) that are brought downward into contact with the laminate or pouch, and impart a seal to the pouch. The preferred embodiment provides that the sealing fixtures move vertically. Alternative embodiments provide that sealing section 104 provides other functions, such as cooling, perforating, cutting, punching, etc. These functions may be performed solely, or in combination with other functions. Also, the sealing fixture can be top mounted (brought downward to make the seal), bottom mounted (moved upward to make the seal), or with two fixtures, one top mounted and the other bottom mounted (the two fixtures move together—one up and one down) to make the seal. Other embodiments provide for the movements to be other than horizontal and vertical.

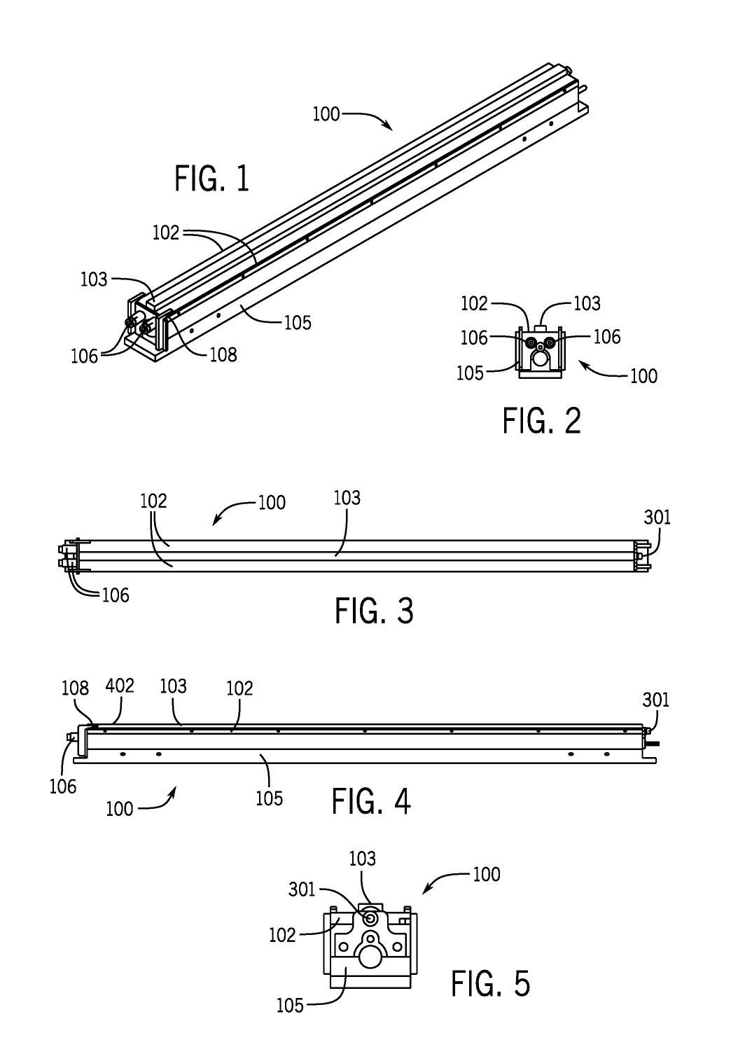

Referring now to FIGS. 1-14 all or part of a seal bar 100 is shown. Seal bar 100 preferably is mounted above the film, and moves downward to the film to form the seal. A mating backing member is preferably disposed below the film. When the film is pinched between seal bar 100 and the mating backing heat and pressure act to melt the film and form the seal. On various embodiments inserts are sealed into the film. Alternatives include no mating backing member, a seal bar above and below the film, or a seal bar below the film and a backing above the film.

FIG. 1 shows a perspective view of seal bar 100. Except as described herein seal bar can be consistent with the prior art, although any design could use the features described herein. The preferred embodiment will be described with seal bar 100 forming a cross machine direction seal. Thus, seal bar 100 extends from near one side of the film, to near the opposite side of the film. Seal bar 100 includes a sealing member 102 and a base 105. Sealing member 102 includes seal surface 103, which is raised and touches (and melts) the film during the operation while the film is not moving. The sealing member 102 is changed when it wears or the seal pattern is changed. Base 105 is not removable and remains in place even when sealing member 102 is changed. Not removable, as used herein, refers to a structure that is not normally removed during routine maintenance and/or is held in place with screws, bolts, etc. The seal bar described herein provides an easy and fast way to change sealing member 102.

Base 105 includes springs 106 which help hold (as will be described in more detail below) sealing member 102 in the desired position. Clips 108 also help to hold sealing member 102 in place. Clip refers to any protrusion on one member that serves to hold another member ion a desired location. Springs 106 and clip 108 can be any easy release structure that holds sealing member 102 to base 105. Easy release structure refers to some structure that hold objects together without require turning a bolt and without accessing the structure, such as a clip, spring, dove tail, etc. A clip that is held in place or released by the user moving a part is not an easy release structure because the user must access the structure to move the part.

Referring now to FIG. 2 an end view of seal bat 100 is shown. Springs 106 can be more readily seen in this view.

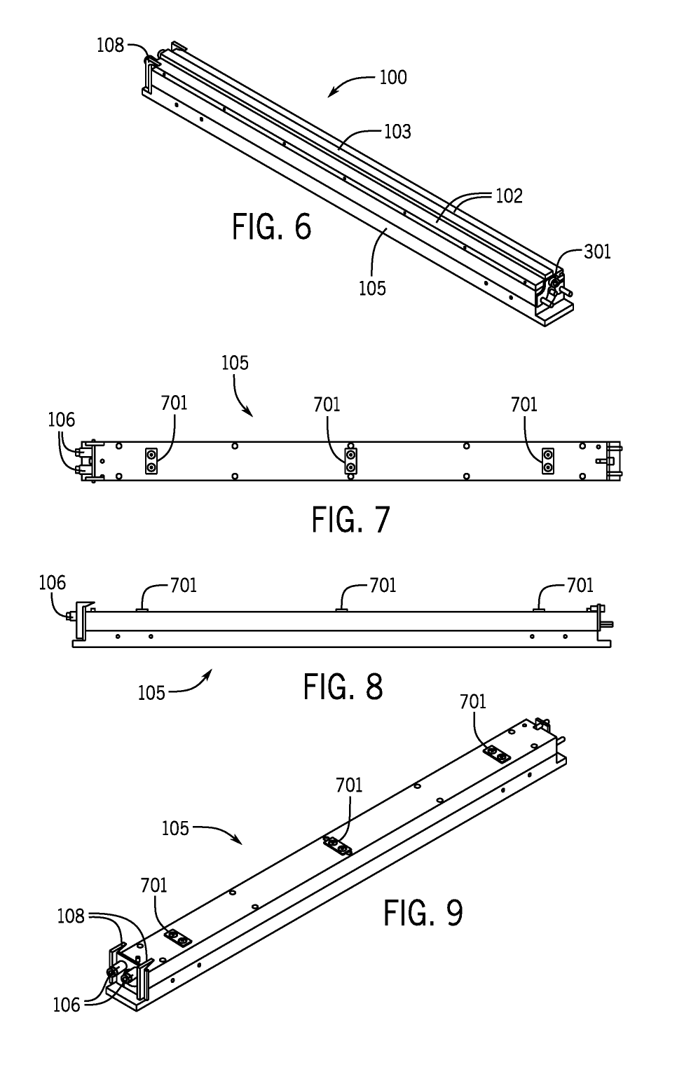

Referring now to FIGS. 3 and 4 a top and side view of seal bar 100 is shown. It can be seen that clip 108 extends over a tab 402 of sealing member 102, thus preventing the end of seal bar 100 from lifting away from base 105. An attachment structure 301 is disposed at the end of seal bar 100, opposite springs 106. Attachment structure 301 is a threaded bolt hole 301 in the preferred embodiment, but can be any attachment structure. Attachment structure, as used herein, refers to a structure to which another device can be attached, such as a threaded hole, a ball bearing detent and collet, etc. Bolt hole 301 can be readily seen in FIG. 5, which is an end view of seal bar 100. Bolt hole 301 can be also readily seen in FIG. 6, which is a perspective view of seal bar 100. The use of bolt hole 201 to remove sealing member 201 will be described in greater detail below.

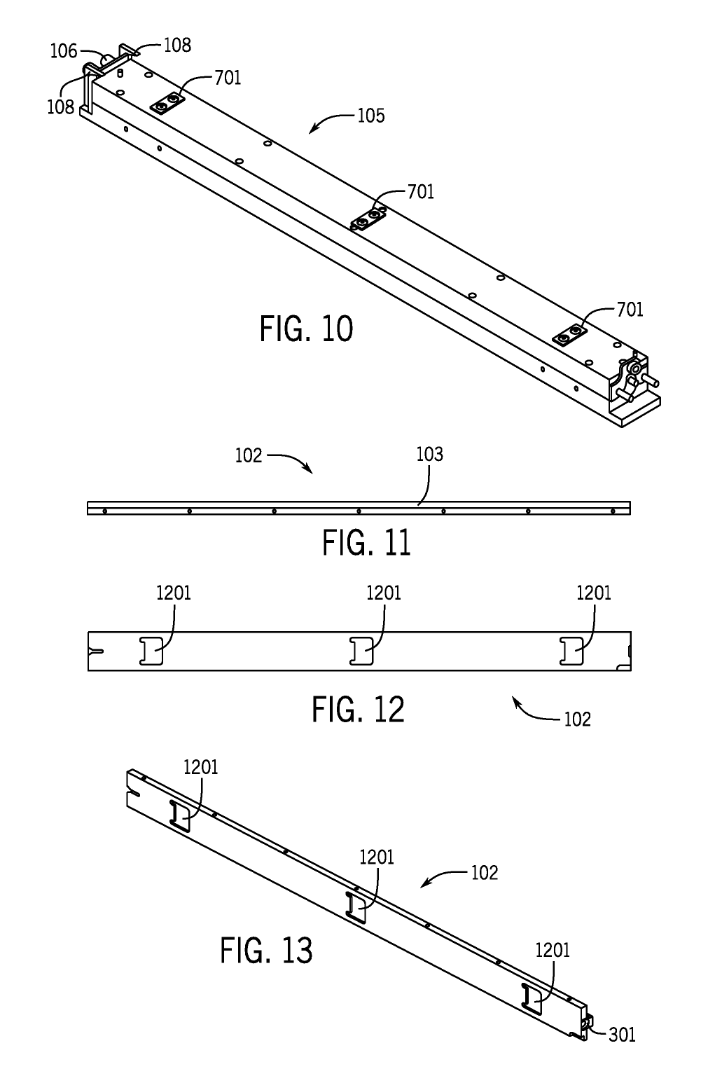

FIGS. 7-10 show base 105 of seal bar 100 without sealing member 102 attached. FIG. 7 is a top view, FIG. 8 is a side view, and FIGS. 9 and 10 are perspective views. Clips 108 are readily seen in FIGS. 8-10, and it can be seen that sealing member 102 can slide under clips 108. The top surface of base 105 (which supports the bottom surface of sealing member 102) includes three tenons 701. Tenons 701 cooperate with mortises on the bottom of sealing member 102 to form a dove tail joint. Dove tail, as used herein, refers to a joint formed by one or more tapered projections (tenons) on one piece that interlock with corresponding notches or recesses (mortises) in another. Alternatives provide for using other easy release structures in place of dove tails.

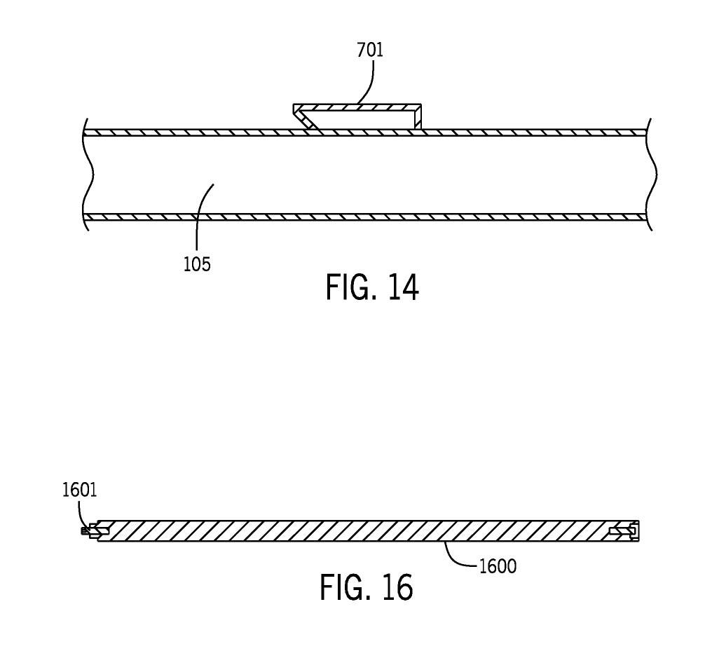

Tenon 701 can be seen in greater detail in FIG. 14, and has a wedge shaped. The wedge of tenon 701 mates with a matching recess in the bottom of sealing member 102 to help hold sealing member 102 to base 105.

Turning now to FIGS. 11-13, sealing member 102 is shown in greater detail. FIG. 11 is a side view of sealing member 102. FIG. 12 is a bottom view of sealing member 102, and FIG. 13 is a perspective view of sealing member 102. The bottom os sealing member 102 includes recesses (or mortices) 1201 that cooperate with tenons 701 on base 105. Sealing member is held in place by sliding one end under clips 108. Sealing member 102 is then pushed toward springs 106, compressing springs 106. This allows recess 1201 to slide over tenons 701. Sealing member 102 is then tightly held to base 105 by the springs, clips and dove tails.

Bolt hole 301 is used to help remove and insert sealing member 102 in place. To remove sealing member 102, a tool such as rod 1600 (FIG. 16) with a threaded end 1601 is turned into threaded bolt hole 301. Then, rod 1600 is pushed toward springs 106, which causes springs 106 to compress, disengaging the dove tail telons 701 from mortices 1201. This allows the end of sealing member 301 with threaded hole 306 to be lifted. Then, sealing member 102 is pulled back away from springs 106 (or allowed to be pushed by springs 106), and the end of sealing member 102 is slid out from under clips 108. Because sealing member 102 is not secured to base 105 with any screws, bolts etc, and only with easy release structures (springs 106, clips 108 and dove tail joints 701/121) are used, sealing member 102 is quickly and easily removed. Moreover, it is done so without the need to touch the hot surfaces (or any surfaces) of sealing member 102. This removal works particularly well with cross direction seal bars, because the entire seal bar can be removed from one side.

Inserting sealing member 102 in place simply entails reversing the process. To insert remove sealing member 102, rod 1600 (FIG. 16) with threaded end 1601 is turned into threaded bolt hole 301. Then, rod 1600 is pushed toward springs 106 and sealing member 102 is slid under clips 108. Rod 1600 is further pushed, which causes springs 106 to compress, and the end of sealing member 301 with threaded hole 306 is lowered so that dove tail mortices 1201 are over dove tail telons 701. Then rod 1600 is allowed to be pushed back by springs 106, engaging dove tail telons 701 with mortices 1201. Thus sealing member 102 is quickly and easily secured without screws, bolts etc affixing sealing member 102 to base 105. Rather, only easy release structures (springs 106, clips 108 and dove tail joints 701/121) secure sealing member 102 to base 105, and it is done without touching any surfaces of sealing member 102.

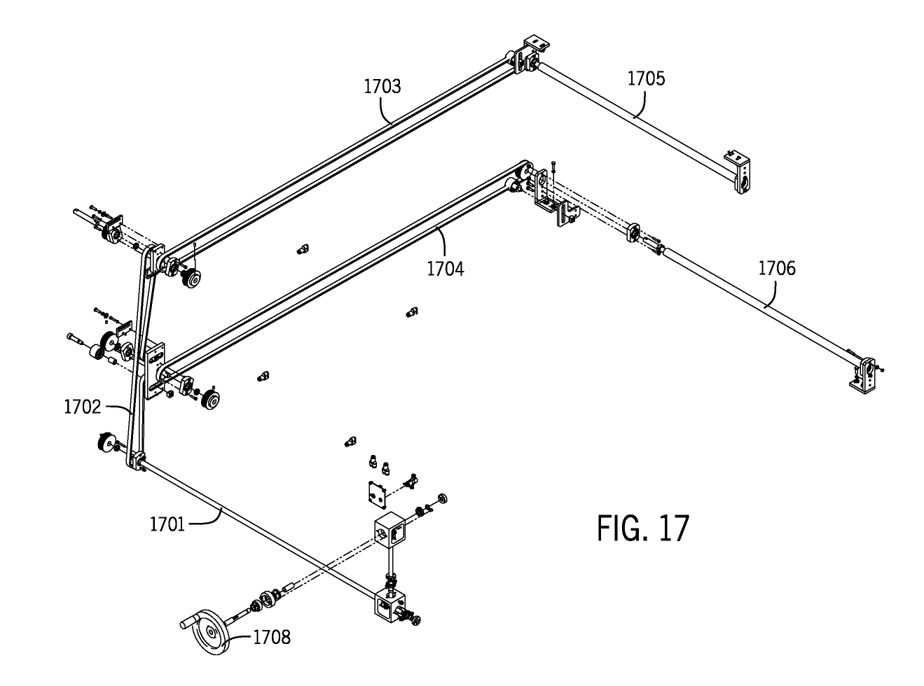

Another aspect of this disclosure provides for adjusting both of a seal bar and mating backing (or one of two mating seal bars) on opposite sides of the film with a single mechanism, such their alignment is maintained. In other words, when one of the mating members is moved in a plane parallel to the film, the other mating member is moved in a like manner in a plane parallel to the film. This is accomplished through linkages such as timing belts. FIG. 17 shows linkages 1701-1706 that cause top and bottom sealing members to move in unison, thus preserving their alignment. A crank 1708 is turned, which turns linkage rod 1701. When rod 1701 turns, linkage timing belt 1702 moves. When linkage timing belt 1702 moves, linkage timing belts 1703 and 1704 each move equal distances. When linkage timing belt 1703 moves, linkage rod 1705 turns, and when timing belts 1704 moves, linkage rod 1706 turns. When linkage timing belt 1703 moves, linkage rod 1705 turns, and when timing belts 1704 moves, linkage rod 1706 turns. When threaded linkage rod 1705 turns, the mount for the upper sealing member moves along the threads of rod 1705, and when threaded linkage rod 1706 turns, the mount for the lower sealing member moves along the threads of rod 1706. Thus, by turning crank 1708 the upper and lower sealing members (seal bars and/or backing) are moved equal amounts. The preferred embodiment provides that rods 1705 and 1706 extend in the cross direction, so turning crank 1708 moves the sealing members toward or away from the edge. A set of linkages 1701-1706 are used on both sides of the machine, so that seal bars are both sides can be adjusted. Alternatives provide for other linkages (and with a different number of linkages).

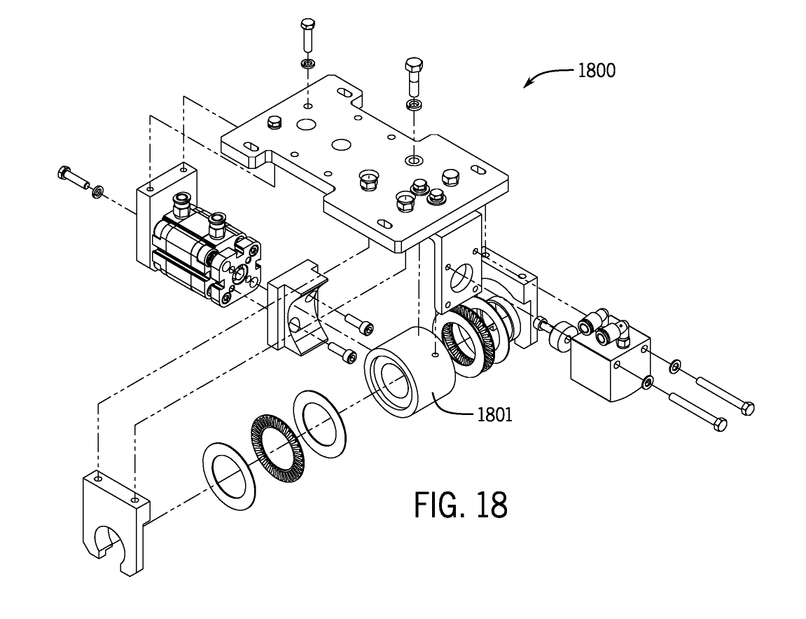

Turning now to FIG. 18, a mount 1800 for upper and lower sealing members are shown. A threaded nut 1801 receives threaded rod 1705 for moving mount 1800. The load support for mount 1800 is not shown, and can be consistent with the prior art, or any other load support desired.

Numerous modifications may be made to the present disclosure which still fall within the intended scope hereof. Thus, it should be apparent that there has been provided a method and apparatus for making pouches with easy adjusted seal bars and easily removed sealing members that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

The embodiments of the invention in which an exclusive property or privilege is claimed are defined as follows:

1. A pouch machine with at least one seal bar, wherein the seal bar includes a base that is not removable and a removable sealing member that is held to the base using at least one easy release structure.

2. The pouch machine of claim 1, wherein the at least one easy release structure is at least one of a spring, a clip and a dove tail.

3. The pouch machine of claim 1, wherein the removable sealing member is held to the base using a plurality of easy release structures.

4. The pouch machine of claim 3, wherein the plurality of easy release structures includes at least one of a spring, a clip and a dove tail.

5. The pouch machine of claim 4, wherein plurality of easy release structures include at least one spring, at least one clip and a at least one dove tail.

6. The pouch machine of claim 1, wherein the removable sealing member fixedly receives a tool that can lift and remove the removable sealing member.

7. The pouch machine of claim 1, wherein the removable sealing member includes a threaded hole that threadedly receives a rod that can lift and remove the removable sealing member.

8. The pouch machine of claim 1, wherein the at least one seal bar is a cross direction seal bar.

9. A pouch machine with at least one seal bar, wherein the seal bar includes a top member and a mating bottom member, wherein in operation the top member is above a film and the bottom member is below the film, and wherein a seal is formed on the film where the top member and bottom member mate, and wherein a linkage connects the top member and the bottom member such that when an adjustment of the position of one of the top member and the bottom member in a plane parallel to the film is made, a like adjustment a second plane parallel to the film is made to the other of the top member and the bottom member.

10. The pouch machine of claim 9, further comprising a crank connected to the linkage, wherein turning the crank results in the adjustment of the position of the one of the top member and the bottom member in the plane parallel to the film is made, and the like adjustment in the second plane parallel to the film is made to the other of the top member and the bottom member.

11. The pouch machine of claim 9, wherein the linkage includes at least one of a timing belt and a threaded rod.

12. The pouch machine of claim 10, wherein the linkage includes both of the timing belt and the threaded rod.

13. The pouch machine of claim 9, wherein the at least one seal bar is in the machine direction.

14. The pouch machine of claim 13, further comprising a second seal bar is in a cross direction, wherein the second seal bar includes a base that is not removable and a removable sealing member that is held to the base using at least one easy release structure.
